(19) United States
(12) Patent Application Publication
(10) Pub. No.: US 2017/0080698 A1
(43) Pub. Date: Mar. 23, 2017

(54) ADHESIVE SHEET AND ADHESIVE-SHEET APPLICATION METHOD

(71) Applicant: NITTO DENKO CORPORATION, Osaka (JP)

(72) Inventors: Hiroshi WADA, Osaka (JP); Yuki TSUBAKI, Osaka (JP); Takahisa KUSUURA, Tokyo (JP); Kouya SAKUMA, Aichi (JP)

(73) Assignee: NITTO DENKO CORPORATION, Osaka (JP)

(21) Appl. No.: 15/269,263

(22) Filed: Sep. 19, 2016

(30) Foreign Application Priority Data
Sep. 23, 2015 (JP) 2015-186182

(51) Int. Cl. B32B 38/00; C09J 133/08; C09J 7/02; C09J 183/04; B32B 43/00; C09J 5/00

(52) U.S. Cl. CPC B32B 38/0012; B32B 43/006; C09J 5/00; C09J 7/0232; C09J 183/04; C09J 7/0217; C09J 7/0228; C09J 133/08; C09J 2201/20; C09J 2201/32; C09J 2433/00

(57) ABSTRACT

The present invention relates to an adhesive sheet including an adhesive layer and a release liner disposed on one surface of the adhesive layer, in which the adhesive layer is configured so as to show follow-up deformations in response to peeling of the release liner from the adhesive layer and have first areas having a first follow-up deformation height and second areas having a second follow-up deformation height, in which the first follow-up deformation height is a height dimension of the follow-up deformation in the first areas, the second follow-up deformation height is a height dimension of the follow-up deformation in the second areas, and the second follow-up deformation height is larger than the first follow-up deformation height.

### FIELD OF THE INVENTION

The present invention relates to an adhesive sheet and an adhesive-sheet application method.

### BACKGROUND OF THE INVENTION

An adhesive sheet is a sheet-shaped object to which an adhesive has been applied beforehand and, hence, has an advantage in that the adhesive sheet is free from the trouble of applying an adhesive each time a sheet-shaped object is applied to an adherend. Such adhesive sheets are used in various applications.

However, general adhesive sheets have had a problem in that since the adhesive sheets each have a flat adhesive layer having an even thickness, there are cases where air bubbles are trapped when applying the adhesive sheet to an adherend, if a sufficient care is not taken in the application, and it is difficult to expel the air bubbles which have been trapped.

Known as an adhesive sheet for preventing such air bubble trapping is, for example, an adhesive sheet in which fine beads have been dispersedly disposed near the surface of the adhesive layer to form, on the surface of the adhesive layer, recesses and protrusions due to the fine beads. This adhesive sheet is intended so that when applying the adhesive sheet to an adherend, channel areas for air bubble expelling (the gap between the adhesive layer and the adherend) which are based on the recesses and protrusions are formed between the adhesive layer and the adherend. In this adhesive sheet, the channel areas formed upon application of the adhesive layer to an adherend gradually disappear due to the flowability of the adhesive layer and it is possible to expel the trapped air bubbles with the disappearance of the channel areas. In addition, the increased area of contact with the adherend brings about high adhesive strength.

### SUMMARY OF THE INVENTION

The adhesive sheet including fine beads described above exhibits the function of effectively expelling air bubbles, so long as the fine beads are present near the surface of the adhesive layer at the time when the adhesive sheet is applied to an adherend. However, there has been a problem in that the fine beads which were dispersedly disposed in the surface of the adhesive layer are gradually buried in the adhesive layer with the lapse of time from the production to just before application and, as a result, when actually applying this adhesive sheet to an adherend, it has become impossible to form channel areas which are based on recesses and protrusions and are capable of sufficiently exhibiting the function of expelling air bubbles.

An object of the present invention, which has been achieved in order to overcome the problem, is to provide an adhesive sheet which can sufficiently exhibit the function of expelling air bubbles, at the time of application to an adherend. Another object of the present invention is to provide a method for applying such an adhesive sheet.

The above-mentioned object is achieved by an adhesive sheet including an adhesive layer and a release liner disposed on one surface of the adhesive layer, in which the adhesive layer is configured so as to show follow-up deformations in response to peeling of the release liner from the adhesive layer and have first areas having a first follow-up deformation height and second areas having a second follow-up deformation height, in which the first follow-up deformation height is a height dimension of the follow-up deformation in the first areas, the second follow-up deformation height is a height dimension of the follow-up deformation in the second areas, and the second follow-up deformation height is larger than the first follow-up deformation height.

In this adhesive sheet, a difference between the second follow-up deformation height and the first follow-up deformation height is preferably 0.5 μm to 500 μm, and more preferably 1.0 μm to 400 μm. Additionally, the difference between the second follow-up deformation height and the first follow-up deformation height is still more preferably 10 μm to 350 μm, further preferably 15 μm to 300 μm, and still further preferably 25 μm to 250 μm.

It is preferable that the second areas include a plurality of small domains dispersedly formed in the adhesive layer, and the first areas are disposed so as to surround each small domain.

It is preferable that an adhesive disposed in regions in the adhesive layer which correspond to the small domains has a higher adhesive force or higher plasticity than an adhesive disposed in regions in the adhesive layer which correspond to the first areas.

It is preferable that the regions in the adhesive layer which correspond to the small domains have slits formed by incising the adhesive layer in a thickness direction thereof.

It is preferable that a surface of regions in the release liner which correspond to the small domains has lower releasability from the adhesive layer than a surface of regions in the release liner which correspond to the first areas.

It is preferable that the adhesive sheet further includes a substrate on which the adhesive layer is disposed, and a surface of regions in the substrate which correspond to the small domains has higher releasability from the adhesive layer than a surface of regions in the substrate which correspond to the first areas.

Additionally, the above-mentioned object of the present invention is achieved by an adhesive-sheet application method for applying to an adherend an adhesive sheet including an adhesive layer and a release liner disposed on one surface of the adhesive layer, the method including: a step in which the release liner is peeled from the adhesive layer, whereby portions of the adhesive layer is caused to follow up the release liner to form surface irregularities on the adhesive layer.

According to the present invention, it is possible to provide an adhesive sheet which can sufficiently exhibit the function of expelling air bubbles, at the time of application to an adherend. It is also possible to provide a method for applying such an adhesive sheet.

### BRIEF DESCRIPTION OF THE DRAWING

FIG. 1 is a diagrammatic cross-sectional view which illustrates the configuration of an adhesive sheet according to the present invention.

FIGS. 2A to 2C are views for illustrating the function of the adhesive sheet according to the present invention.

FIGS. 3A and 3B are diagrammatic cross-sectional views for illustrating the configuration of an adhesive sheet according to a first embodiment of the present invention.

FIG. 4 is a diagrammatic plan view which illustrates the configuration of the adhesive layer included in an adhesive sheet according to a second embodiment of the present invention.

FIGS. 5A to 5D are diagrammatic plan views which illustrate the configurations of modifications of the adhesive layer shown in FIG. 4.

FIG. 6 is a diagrammatic cross-sectional view for illustrating the configuration of an adhesive sheet according to a third embodiment of the present invention.

FIG. 7 is a diagrammatic cross-sectional view for illustrating the configuration of an adhesive sheet according to a fourth embodiment of the present invention.

FIG. 8 is a view for illustrating the function of the adhesive sheet shown in FIG. 7.

FIGS. 9A and 9B are views for illustrating modifications of the adhesive sheet according to the present invention.

FIG. 10 is a view for illustrating a modification of the adhesive sheet according to the present invention.

### DETAILED DESCRIPTION OF THE INVENTION

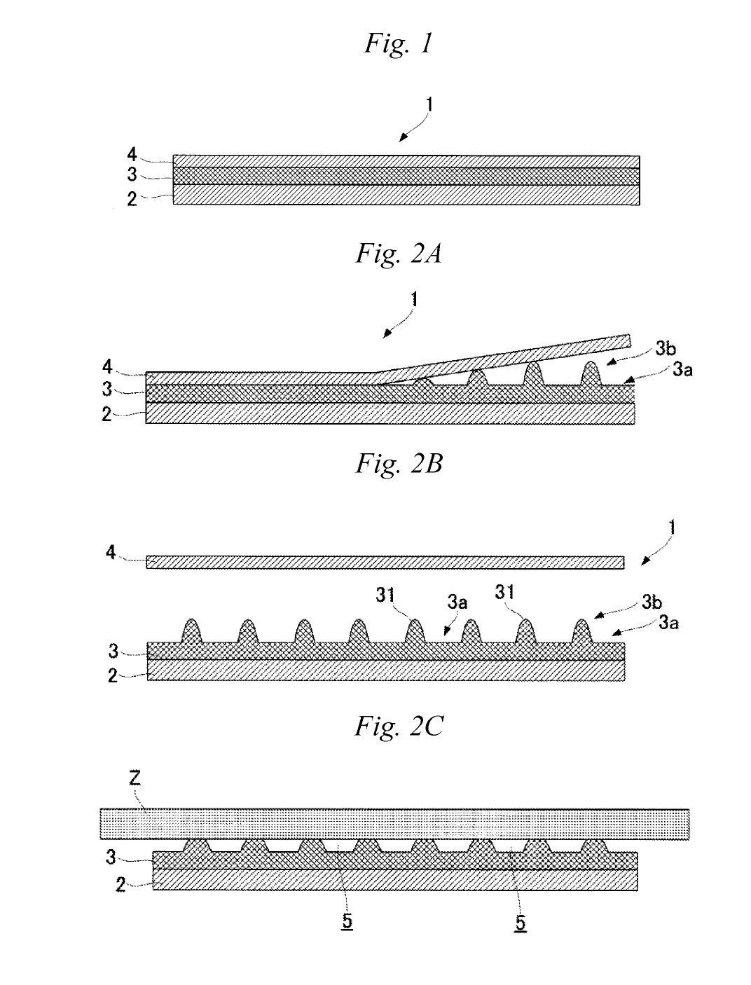

Adhesive sheets according to embodiments of the present invention are explained below while referring to the accompanying drawings. Each drawing has been partly enlarged or reduced for the purpose of easy understanding of the configuration. FIG. 1 is a diagrammatic cross-sectional view which illustrates the configuration of an adhesive sheet according to a first embodiment of the present invention. The adhesive sheet 1 according to the present invention is an adhesive sheet 1 to be applied to an adherend, and includes a substrate 2, an adhesive layer 3, and a release liner 4, as shown in FIG. 1. The adhesive layer 3 is disposed on one surface of the substrate 2, and the release liner 4 is disposed on a surface of the adhesive layer 3 which is on the reverse side from the substrate 2.

In the adhesive sheet 1 according to the present invention, as shown in FIGS. 2A and 2B, during the period when the release liner 4 is peeled from the adhesive layer 3, the adhesive layer 3 is configured so as to show follow-up deformations in response to the peeling of the release liner 4 from the adhesive layer 3 and have first areas 3a having a first follow-up deformation height and second areas 3b having a second follow-up deformation height, in which the first follow-up deformation height is a height dimension of the follow-up deformation in the first areas 3a and the second follow-up deformation height is a height dimension of the follow-up deformation in the second areas 3b. The term “follow-up deformation” herein means a phenomenon in which during the period when the release liner 4 is peeled from the adhesive layer 3, the surface of the adhesive layer 3 which is adherent to the surface of the release liner 4 is pulled by and follows up the release liner 4 and the adhesive layer 3 hence deforms so as to protrude upward (toward the release liner 4 side). The term “height dimension of the follow-up deformation” means the difference in height dimension between before and after the deformation. The term “first follow-up deformation height” means the follow-up deformation height dimension in the first areas 3a after the peeling of the release liner 4 from the adhesive layer 3, while the term “second follow-up deformation height” means the follow-up deformation height dimension in the second areas 3b after the peeling of the release liner 4 from the adhesive layer 3. Meanwhile, the adhesive layer 3 is configured so that the second follow-up deformation height in the second areas 3b is larger than the first follow-up deformation height in the first areas 3a. It is preferable that the adhesive layer 3 is configured so that the first follow-up deformation height in the first areas 3a is in the range of, for example, −2 μm to 5 μm, more preferably in the range of −1 μm to 2 μm. It is also preferable that the adhesive layer 3 is configured so that the second follow-up deformation height in the second areas 3b is in the range of 1 μm to 500 μm, more preferably in the range of 1 μm to 300 μm. Furthermore, it is preferable that the adhesive layer 3 is configured so that the difference between the second follow-up deformation height and the first follow-up deformation height is, for example, 0.5 μm to 500 μm, more preferably 1 μm to 300 μm. It is noted that there are cases where a large follow-up deformation in a second area 3b causes a first area 3a which adjoins the second area 3b to deform so as to sink with respect to the reference surface of the adhesive layer 3 which has not been deformed. Hence, the numerical ranges shown above as examples include one in which the first follow-up deformation height in the first areas 3a can be less than 0.

It is preferable, as shown in FIG. 2B, that the second areas 3b, in which the adhesive layer 3 has a large height dimension of the follow-up deformation in response to peeling of the release liner 4, includes a plurality of small domains 31 dispersedly formed in the adhesive layer 3 so that these small domains 31 as a whole constitute the second areas 3b and that the first areas 3a are disposed so as to surround each small domain 31.

The adhesive sheet 1 having such a configuration produces the following effects. By the simple operation of peeling and removing the release liner 4 from the adhesive layer 3 just before application of the adhesive sheet 1 to an adherend, surface irregularities in which portions of the adhesive layer 3 which correspond to the second areas 3b protrude from portions of the adhesive layer 3 which correspond to the first areas 3a can be formed on the surface of the adhesive layer 3 (FIG. 2B). Due to this configuration, upon application of the adhesive sheet 1 to an adherend Z, channel areas 5 (gap) for air bubble expelling which are based on the surface irregularities can be formed without fail between the adhesive sheet 1 and the adherend Z, as shown in FIG. 2C. Through the channel areas 5, the air bubbles which have been trapped during the application of the adhesive sheet can be effectively expelled.

Due to the formation of the surface irregularities for air bubble expelling on the surface of the adhesive layer 3, the adhesive layer 3, immediately after application of the adhesive sheet 1 to an adherend Z, is in the state of being adherent to the adherend Z in a small contact area. Because of this, in cases when, for example, the adhesive sheet 1 has been applied in a wrong position, the adhesive sheet 1 can be easily stripped off and applied again to the adherend Z.

The surface irregularities formed (deformation in the second areas 3b of the adhesive layer 3) disappear with the lapse of time because of the flowability of the adhesive layer 3 or are made to disappear by pressing the adhesive sheet. As a result, the area of contact between the adhesive layer 3 and the adherend Z increases and, hence, the adhesive sheet 1 comes to have improved adhesive performance including adhesive force and repulsion resistance.

By configuring the adhesive layer 3 so that the difference between the second follow-up deformation height and the first follow-up deformation height is 0.5 μm to 500 μm, not only the channel areas 5 for expelling air bubbles to be trapped upon application to an adherend Z can be sufficiently ensured but also it is possible to effectively inhibit the trouble that when the channel areas 5 gradually disappear due to the flow of the adhesive layer 3, some of the channel areas 5 remain.

First to fourth embodiments, which employ more specific configurations according to the present invention, are explained below. It is a matter of course that configurations other than those of the first to fourth embodiments can be employed so long as the effect of the present invention described above can be achieved therewith.

First, the first embodiment is explained. An adhesive sheet 1 according to the first embodiment includes a substrate 2, a release liner 4, and an adhesive layer 3. The adhesive layer 3 is interposed between the substrate 2 and the release liner 4. The adhesive sheet according to the first embodiment is characterized by the structure of the adhesive layer 3.

As the substrate 2, use can be made of one which is generally used as the substrates 2 of adhesive sheets. Examples of the material constituting the substrate 2 include resinous materials (e.g., sheet-shaped or net-shaped materials, woven fabric, nonwoven fabric, and foamed sheets), paper, and metals. The substrate 2 may be constituted of a single layer, or may be composed of multiple layers constituted of the same or different materials. Examples of resins for constituting the substrate 2 include polyesters, polyolefins, ethylene/vinyl acetate copolymers, ethylene/(meth)acrylic acid copolymers, ethylene/(meth)acrylic ester copolymers, ethylene/butene copolymers, ethylene/hexene copolymers, polyurethanes, polyetherketones, poly(vinyl alcohol), poly(vinylidene chloride), poly(vinyl chloride), vinyl chloride/vinyl acetate copolymers, poly(vinyl acetate), polyamides, polyimides, cellulosic resins, fluororesins, silicone resins, polyethers, polystyrene-based resins (e.g., polystyrene), polycarbonates, polyethersulfones, and crosslinked forms of these resins.

The thickness of the substrate 2 can be suitably set. However, the thickness thereof is preferably 0.5 μm to 1,000 μm, and it is more preferred to set the thickness thereof at a value in the range of 5 μm to 500 μm. Any appropriate surface treatment may be given to the substrate 2 in accordance with purposes. Examples of the surface treatment include a treatment with chromic acid, exposure to ozone, exposure to a flame, exposure to high-voltage electric shocks, treatment with ionizing radiation, matting, corona discharge treatment, priming, and crosslinking.

The release liner 4 is a member which includes a liner base and a release layer (releasing coating film) and which is disposed on the adhesive layer 3 so that the release layer faces the adhesive layer 3. The release layer can be formed from, for example, a silicone-based release agent. Examples of the silicone-based release agent include thermosetting silicone-based release agents and silicone-based release agents curable with ionizing radiation. Materials usable for forming the release layer are not limited to silicone-based release agents, and a suitable one can be selected in accordance with the kind of the adhesive constituting the adhesive layer 3.

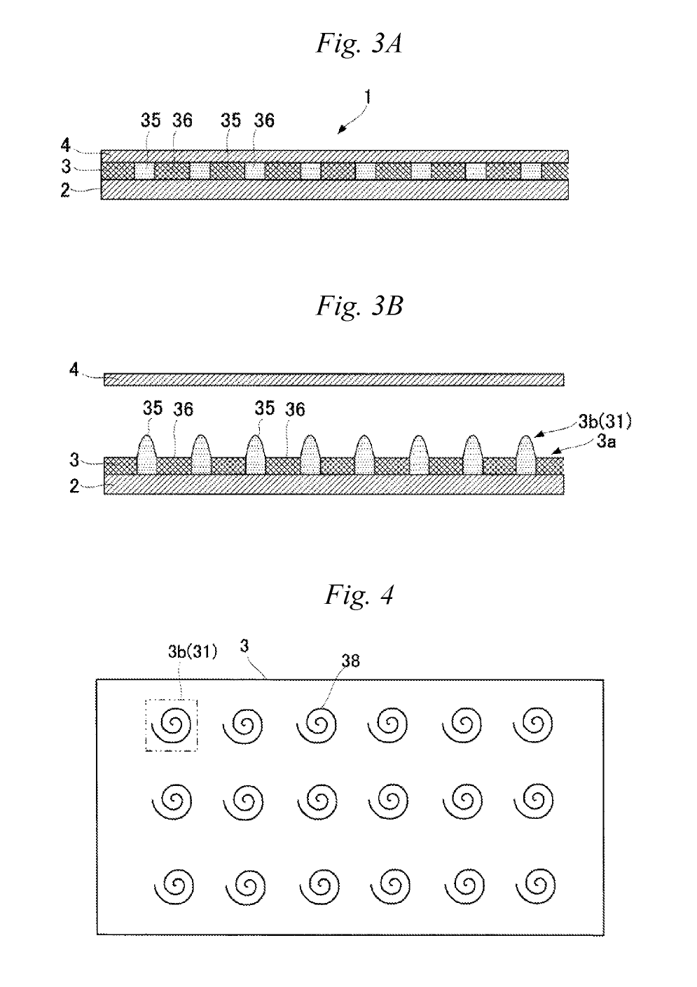

The adhesive layer 3, which is disposed on one surface of the substrate 2, includes regions 35 constituted of an adhesive having a high adhesive force to the release liner 4 and regions 36 constituted of an adhesive having a low adhesive force to the release liner 4, as shown in the diagrammatic cross-sectional view of FIG. 3A. Namely, the adhesive layer 3 is formed so that the adhesive disposed in the regions 35 corresponding to the second areas 3b (small domains 31) has a higher adhesive force to the release liner 4 than the adhesive disposed in the regions 36 corresponding to the first areas 3a. For example, in the case where the release layer of the release liner 4 is a release layer formed from a silicone-based release agent as stated above, the adhesive layer 3 is formed so that an acrylic adhesive is disposed in the regions 36 corresponding to the first areas 3a and that a silicone-based adhesive is disposed in the regions 35 corresponding to the second areas 3b (small domains 31).

The regions 36 (regions corresponding to the first areas 3a) constituted of an acrylic adhesive have high releasability from the release layer constituted of a silicone-based release agent. Consequently, when peeling the release liner 4 form the adhesive layer 3, the regions 36 are smoothly separated from the release liner 4 and are less apt to show a deformation which protrudes upward. Meanwhile, the regions 35 (regions corresponding to the second areas 3b) constituted of a silicone-based adhesive have poor releasability from the release layer constituted of a silicone-based release agent and, hence, adhere to the release liner 4 which is being peeled from the adhesive layer 3. As a result, the regions 35 follow up the release liner 4 with the peeling of the release liner 4 and deform so as to protrude upward (toward the release liner 4 side) as shown in FIG. 3B.

In the adhesive sheet according to the first embodiment, in which the adhesive layer 3 is configured so that the adhesive disposed in the regions 35 corresponding to the second areas 3b (small domains 31) has a higher adhesive force than the adhesive disposed in the regions 36 corresponding to the first areas 3a, it is possible to effectively form surface irregularities on the application surface of the adhesive layer 3 by peeling off the release liner 4, and the effect described above, i.e., the function of sufficiently expelling air bubbles, can be exhibited.

It is preferable that the ratio of the adhesive force, regarding adhesion to the release liner 4, of the adhesive disposed in the regions 36 corresponding to the first areas 3a to the adhesive force, regarding adhesion to the release liner 4, of the adhesive disposed in the regions 35 corresponding to the second areas 3b (small domains 31) is set so as to be in the range of from 1:5 to 1:200. The ratio between the adhesive forces can be determined by measuring the adhesive forces in the following manner. First, the adhesive sheet 1 is cut into a size having a width of 50 mm and a length of 150 mm to produce a sample for evaluation. Subsequently, the surface on the substrate 2 side is adhered to a coated plate with a double-faced tape, and the release liner 4 is then peeled off to measure the force required for peeling off the regions 36 corresponding to the first areas 3a and the force required for peeling off the regions 35 corresponding to the second areas 3b (small domains 31). With respect to the measurement conditions, universal tensile tester “TCM-1kNB”, manufactured by Minebea Co., Ltd., is used to conduct 180-degree peeling at a pulling speed of 300 mm/min in an atmosphere of 23° C. and 50% RH.

In the first embodiment, as the adhesives for forming the adhesive layer 3 and as the material for forming the release layer of the release liner 4, use may be made of any materials so long as the adhesive layer 3 can be made to have a difference in adhesiveness to the release liner 4 so that by the operation of peeling off the release liner 4, regions 35 (corresponding to the second areas 3b) of the adhesive layer 3 are caused to follow up the release liner 4 and deform to protrude upward (toward the release liner 4 side). The adhesive layer 3 can be formed from various adhesives which are generally used as the adhesive layers of adhesive sheets, such as pressure-sensitive adhesives, thermoplastic adhesives, and thermosetting adhesives.

The adhesive layer 3 can be a pressure-sensitive adhesive layer formed from either aqueous pressure-sensitive adhesive compositions or solvent-based pressure-sensitive adhesive compositions. The term “aqueous pressure-sensitive adhesive composition” means a pressure-sensitive adhesive composition configured of a medium including water as the main component (aqueous medium) and a pressure-sensitive adhesive (ingredient for pressure-sensitive-adhesive layer formation) contained in the medium. This conception of aqueous pressure-sensitive adhesive composition can include compositions which are called aqueous dispersion type pressure-sensitive adhesive compositions (compositions of the type configured of water and a pressure-sensitive adhesive dispersed therein), aqueous solution type pressure-sensitive adhesive compositions (compositions of the type configured of water and a pressure-sensitive adhesive dissolved therein), and the like. Meanwhile, the term “solvent-based pressure-sensitive adhesive composition” means a pressure-sensitive adhesive composition configured of an organic solvent and a pressure-sensitive adhesive contained therein.

In the techniques disclosed herein, the kinds of the pressure-sensitive adhesives included in the adhesive layer 3 are not particularly limited. For example, the pressure-sensitive adhesives can be ones which include, as one or more base polymers, one or more polymers selected from among various polymers capable of functioning as pressure-sensitive adhesive ingredients (polymers having pressure-sensitive adhesiveness), such as acrylic polymers, polyesters, urethane polymers, polyethers, rubbers, silicones, polyamides, and fluoropolymers. In a preferred mode, a main component of the adhesive layer 3 is an acrylic pressure-sensitive adhesive. The techniques disclosed herein can be advantageously practiced in the form of a double-faced pressure-sensitive adhesive sheet having pressure-sensitive adhesive layers constituted substantially of acrylic pressure-sensitive adhesives. The pressure-sensitive adhesive layers typically are pressure-sensitive adhesive layers formed from pressure-sensitive adhesive compositions including a polymer having pressure-sensitive adhesiveness (preferably, an acrylic polymer).

The term “acrylic pressure-sensitive adhesive” herein means a pressure-sensitive adhesive which includes an acrylic polymer as a base polymer (a main component of the polymer component(s); i.e., a component accounting for more than 50% by mass of the polymer component(s)). The term “acrylic polymer” means a polymer for which one or more monomers each having at least one (meth)acryloyl group in one molecule thereof (hereinafter, these monomers are often referred to as “acrylic monomers”) were used as a main constituent monomer component (a main component of all the monomers; i.e., a component accounting for more than 50% by mass of all the monomers for constituting the acrylic polymer). In this specification, the term “(meth)acryloyl group” inclusively means an acryloyl group and a methacryloyl group. Likewise, “(meth)acrylate” inclusively means an acrylate and a methacrylate.

The acrylic polymer typically is a polymer produced using one or more alkyl (meth)acrylates as a main constituent monomer component. For example, compounds represented by the following formula (1) are suitably used as the alkyl (meth)acrylates.

CH₂═C(R¹)COOR² (1)

R¹ in formula (1) is a hydrogen atom or a methyl group. R² is an alkyl group having 1-20 carbon atoms. Alkyl (meth)acrylates in which R² is an alkyl group having 2-14 carbon atoms (hereinafter, this range of the number of carbon atoms is often referred to as C₂₋₁₄) are preferred since a pressure-sensitive adhesive having excellent pressure-sensitive adhesive performance is apt to be obtained with such alkyl (meth)acrylates. Examples of the C₂₋₁₄ alkyl group include ethyl, propyl, isopropyl, n-butyl, isobutyl, s-butyl, t-butyl, n-pentyl, isoamyl, neopentyl, n-hexyl, n-heptyl, n-octyl, isooctyl, 2-ethylhexyl, n-nonyl, isononyl, n-decyl, isodecyl, n-undecyl, n-dodecyl, n-tridecyl, and n-tetradecyl.

In a preferred mode, about 50% by mass or more (typically 50-99.9% by mass), more preferably 70% by mass or more (typically 70-99.9% by mass), and, for example, about 85% by mass or more (typically 85-99.9% by mass), of all the monomers to be used for synthesizing the acrylic polymer is accounted for by one or more monomers selected from among alkyl (meth)acrylates represented by formula (1) in which R² is a C₂₋₁₄ alkyl (more preferably C₄₋₁₀-alkyl (meth)acrylates; especially preferably, butyl acrylate and/or 2-ethylhexyl acrylate). Such a monomer composition is preferred because an acrylic polymer obtained therefrom is apt to give a pressure-sensitive adhesive which shows satisfactory pressure-sensitive adhesive properties.

In the techniques disclosed herein, acrylic polymers in which an acrylic monomer having a hydroxyl group (—OH) has been copolymerized can be preferably used. Examples of the acrylic monomer having a hydroxyl group include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 2-hydroxyhexyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, polypropylene glycol mono(meth)acrylate, N-hydroxyethyl(meth)acrylamide, and N-hydroxypropyl(meth)acrylamide. One of such hydroxyl-containing acrylic monomers may be used alone, or two or more thereof may be used in combination.

Such hydroxyl-containing acrylic monomers are preferred because an acrylic polymer in which such a monomer has been copolymerized is apt to give a pressure-sensitive adhesive which has an excellent balance between pressure-sensitive adhesive force and cohesive force and further has excellent re-releasability. Especially preferred examples of the hydroxyl-containing acrylic monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate. For example, a hydroxyalkyl (meth)acrylate in which the alkyl group in the hydroxyalkyl group is a linear group having 2-4 carbon atoms can be preferably used.

It is preferable that such a hydroxyl-containing acrylic monomer is used in an amount in the range of about 0.001-10% by mass based on all the monomers to be used for synthesizing the acrylic polymer. Such use of the hydroxyl-containing acrylic monomer makes it possible to produce a pressure-sensitive adhesive sheet in which the pressure-sensitive adhesive force and the cohesive force are balanced on a higher level. By regulating the use amount of the hydroxyl-containing acrylic monomer to about 0.01-5% by mass (e.g., 0.05-2% by mass), better results can be achieved.

In the acrylic polymer in the techniques disclosed herein, monomers other than those shown above (“other monomers”) may have been copolymerized so long as the effects of the present invention are not considerably impaired. Such monomers can be used, for example, for the purposes of regulating the Tg of the acrylic polymer, regulating the pressure-sensitive adhesive performance (e.g., releasability) thereof, etc. Examples of monomers capable of improving the cohesive force and heat resistance of the pressure-sensitive adhesive include monomers containing a sulfonic group, monomers containing a phosphate group, monomers containing a cyano group, vinyl esters, and aromatic vinyl compounds. Meanwhile, examples of monomers capable of introducing a functional group serving as a crosslinking site into the acrylic polymer or of contributing to an improvement in adhesive strength include monomers containing a carboxyl group, monomers containing an acid anhydride group, monomers containing an amide group, monomers containing an amino group, monomers containing an imido group, monomers containing an epoxy group, (meth)acryloylmorpholine, and vinyl ethers.

Examples of the monomers containing a sulfonic group include styrenesulfonic acid, allylsulfonic acid, 2-(meth)acrylamido-2-methylpropanesulfonic acid, (meth)acrylamidopropanesulfonic acid, sulfopropyl (meth)acrylate, (meth)acryloyloxynaphthalenesulfonic acid, and sodium vinylsulfonate. Examples of the monomers containing a phosphate group include 2-hydroxyethyl acryloyl phosphate. Examples of the monomers containing a cyano group include acrylonitrile and methacrylonitrile. Examples of the vinyl esters include vinyl acetate, vinyl propionate, and vinyl laurate. Examples of the aromatic vinyl compounds include styrene, chlorostyrene, chloromethylstyrene, α-methylstyrene, and other substituted styrenes.

Examples of the monomers containing a carboxyl group include acrylic acid, methacrylic acid, carboxyethyl (meth)acrylate, carboxypentyl (meth)acrylate, itaconic acid, maleic acid, fumaric acid, crotonic acid, and isocrotonic acid. Examples of the monomers containing an acid anhydride group include maleic anhydride, itaconic anhydride, and the acid anhydrides of those carboxyl-containing monomers. Examples of the monomers containing an amide group include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropylmethacrylamide, and diacetoneacrylamide. Examples of the monomers containing an amino group include aminoethyl (meth)acrylate, N,N-dimethylaminoethyl (meth)acrylate, and N,N-dimethylaminopropyl (meth)acrylate. Examples of the monomers containing an imide group include cyclohexylmaleimide, isopropylmaleimide, N-cyclohexylmaleimide, and itaconimide. Examples of the monomers containing an epoxy group include glycidyl (meth)acrylate, methylglycidyl (meth)acrylate, and allyl glycidyl ether. Examples of the vinyl ethers include methyl vinyl ether, ethyl vinyl ether, and isobutyl vinyl ether.

One of such “other monomers” may be used alone, or two or more thereof may be used in combination. However, the total content of such other monomers based on all the monomers to be used for synthesizing the acrylic polymer is preferably about 40% by mass or less (typically 0.001-40% by mass), more preferably about 30% by mass or less (typically 0.01-30% by mass, e.g., 0.1-10% by mass). In the case of using a carboxyl-containing monomer as one of the other monomers, the content thereof based on all the monomers can be, for example, 0.1-10% by mass, and an appropriate range thereof is usually 0.5-5% by mass. Meanwhile, in the case of using a vinyl ester (e.g., vinyl acetate) as one of the other monomers, the content thereof based on all the monomers can be, for example, 0.1-20% by mass, and an appropriate range thereof is usually 0.5-10% by mass.

It is desirable that the comonomer composition for the acrylic polymer is designed so that the polymer has a glass transition temperature (Tg) of −15° C. or lower (typically −70° C. to −15° C.). The Tg thereof is preferably −25° C. or lower (e.g., −60° C. to −25° C.), more preferably −40° C. or lower (e.g., −60° C. to −40° C.). In case where the Tg of the acrylic polymer is too high, there can be cases where the pressure-sensitive adhesive containing this acrylic polymer as a base polymer is prone to be reduced in pressure-sensitive adhesive force (e.g., pressure-sensitive adhesive force in low-temperature environments, pressure-sensitive adhesive force in application to rough surfaces, etc.). In case where the Tg of the acrylic polymer is too low, there can be cases where the pressure-sensitive adhesive has reduced adhesiveness to curved surfaces or has reduced re-releasability (which results in, for example, adhesive transfer).

The Tg of the acrylic polymer can be regulated by suitably changing the monomer composition (i.e., the kinds and proportions of the monomers to be used for synthesizing the polymer). The term “Tg of an acrylic polymer” means a value determined using the Fox equation from the Tg of a homopolymer of each of the monomers used for constituting the polymer and from the mass proportions of the monomers (copolymerization ratio by mass). As the Tg of homopolymers, the values shown in a known document are employed

In the techniques disclosed herein, the following values are specifically used as the Tg of homopolymers.

| | | |
|---|---|---|
| 2-Ethylhexyl acrylate | −70° | C. |
| Butyl acrylate | −55° | C. |
| Ethyl acrylate | −22° | C. |
| Methyl acrylate | 8° | C. |
| Methyl methacrylate | 105° | C. |
| Cyclohexyl methacrylate | 66° | C. |
| Vinyl acetate | 32° | C. |
| Styrene | 100° | C. |
| Acrylic acid | 106° | C. |
| Methacrylic acid | 130° | C. |

With respect to the Tg of homopolymers other than those shown above as examples, the values given in “Polymer Handbook” (3rd ed., John Wiley & Sons, Inc., 1989) are used.

In the case of a monomer, the Tg of a homopolymer of which is not given in “Polymer Handbook” (3rd ed., John Wiley & Sons, Inc., 1989), the value obtained by the following measuring method is used (see JP-A-2007-51271). Specifically, 100 parts by mass of the monomer, 0.2 parts by mass of azobisisobutyronitrile, and 200 parts by mass of ethyl acetate as a polymerization solvent are introduced into a reactor equipped with a thermometer, stirrer, nitrogen introduction tube, and reflux condenser, and the contents are stirred for 1 hour while passing nitrogen gas therethrough. The oxygen present in the polymerization system is thus removed, and the contents are then heated to 63° C. to react the monomer for 10 hours. Subsequently, the reaction mixture is cooled to room temperature to obtain a homopolymer solution having a solid concentration of 33% by mass. This homopolymer solution is then applied to a release liner by casting and dried to produce a test sample (sheet-shaped homopolymer) having a thickness of about 2 mm. A disk-shaped specimen having a diameter of 7.9 mm is punched out from the test sample, sandwiched between parallel plates, and examined for viscoelasticity using a viscoelastometer (trade name “ARES”, manufactured by Rheometric Inc.) in the shear mode under the conditions of a temperature range of −70 to 150° C. and a heating rate of 5° C./min while giving thereto a shear strain with a frequency of 1 Hz. The temperature corresponding to the tan δ (loss tangent) peak top is taken as the Tg of the homopolymer.

It is preferable that the pressure-sensitive adhesive in the techniques disclosed herein is designed so that the peak top temperature regarding the shear loss modulus G″ thereof is −10° C. or lower (typically −10° C. to −40° C.). For example, a preferred pressure-sensitive adhesive is one which is designed so that the peak top temperature is −15° C. to −35° C. In this specification, the peak top temperature regarding shear loss modulus G″ can be understood by punching out a disk-shaped specimen having a diameter of 7.9 mm from a sheet-shaped pressure-sensitive adhesive having a thickness of 1 mm, sandwiching the specimen between parallel plates, examining the specimen for the temperature dependence of loss modulus G″ using the viscoelastometer (trade name “ARES”, manufactured by Rheometric Inc.) in the shear mode under the conditions of a temperature range of −70 to 150° C. and a heating rate of 5° C./min while giving thereto a shear strain with a frequency of 1 Hz, and determining the temperature corresponding to the top of a peak of the temperature dependence (i.e., the temperature at which the G″ curve is maximal). The peak top temperature regarding shear loss modulus G″ of the acrylic polymer can be regulated by suitably changing the monomer composition (i.e., the kinds and proportions of the monomers to be used for synthesizing the polymer).

Methods for obtaining an acrylic polymer having such monomer composition are not particularly limited, and various polymerization methods known as techniques for synthesizing acrylic polymers, such as solution polymerization, emulsion polymerization, bulk polymerization, and suspension polymerization, can be suitably employed. For example, solution polymerization can be preferably used. As a method for feeding monomers when performing solution polymerization, use can be suitably made of an en bloc monomer introduction method, in which all the starting monomers are fed at a time, a continuous-feeding (dropping) method, installment-feeding (dropping) method, or the like. A polymerization temperature can be suitably selected in accordance with the kinds of the monomers and solvent used, the kind of the polymerization initiator, etc. For example, the temperature can be about 20-170° C. (typically 40-140° C.).

The solvent to be used for the solution polymerization can be suitably selected from known or common organic solvents. For example, use can be made of any one of the following solvents or a mixed solvent composed of two or more of the following solvents: aromatic compounds (typically aromatic hydrocarbons) such as toluene and xylene; aliphatic or alicyclic hydrocarbons such as ethyl acetate, hexane, cyclohexane, and methylcyclohexane; halogenated alkanes such as 1,2-dichloroethane; lower alcohols (e.g., monohydric alcohols having 1-4 carbon atoms) such as isopropyl alcohol, 1-butanol, sec-butanol, and tert-butanol; ethers such as tert-butyl methyl ether; ketones such as methyl ethyl ketone and acetylacetone; and the like. It is preferred to use an organic solvent (which can be a mixed solvent) having a boiling point of 20-200° C. (more preferably 25-150° C.) at a total pressure of 1 atm.

The initiator to be used in the polymerization can be suitably selected from known or common polymerization initiators in accordance with the kind of the polymerization method. For example, an azo polymerization initiator can be preferably used. Examples of the azo polymerization initiator include 2,2′-azobisisobutyronitrile, 2,2′-azobis(2-methylpropionamidine) disulfate, 2,2′-azobis(2-amidinopropane) dihydrochloride, 2,2′-azobis[2-(5-methyl-2-imidazolin-2-yl)propane] dihydrochloride, 2,2′-azobis(N,N′-dimethyleneisobutylamidine), 2,2′-azobis[N-2-carboxyethyl]-2-methylpropionamidine] hydrate, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), and dimethyl 2,2′-azobis(2-methylpropionate).

Other examples of the polymerization initiator include: persulfates such as potassium persulfate and ammonium persulfate; peroxide initiators such as benzoyl peroxide, t-butyl hydroperoxide, di-t-butyl peroxide, t-butyl peroxybenozate, dicumyl peroxide, 1,1-bis(t-butylperoxy)-3,3,5-trimethylcyclohexane, 1,1-bis(t-butylperoxy)cyclododecane, and hydrogen peroxide; substituted-ethane initiators such as phenyl-substituted ethanes; and aromatic carbonyl compounds. Still other examples of the polymerization initiator include redox initiators each based on a combination of a peroxide and a reducing agent. Examples of the redox initiators include a combination of a peroxide and ascorbic acid (e.g., combination of hydrogen peroxide and ascorbic acid), a combination of a peroxide and an iron(II) salt (e.g., combination of hydrogen peroxide and an iron(II) salt), and a combination of a persulfate and sodium hydrogen sulfite.

One of such polymerization initiators can be used alone, or two or more thereof can be used in combination. The polymerization initiator may be used in an ordinary amount. For example, the use amount thereof can be selected from the range of about 0.005-1 part by mass (typically 0.01-1 part by mass) per 100 parts by mass of all the monomer ingredients.

According to this solution polymerization, a liquid polymerization reaction mixture in the form of a solution of an acrylic polymer in the organic solvent is obtained. This liquid polymerization reaction mixture as such or after having undergone an appropriate post-treatment can be preferably used as the acrylic polymer in the techniques disclosed herein. Typically, the acrylic-polymer-containing solution which has undergone a post-treatment is regulated so as to have an appropriate viscosity (concentration) and then used. Alternatively, use may be made of a solution obtained by synthesizing an acrylic polymer by a polymerization method other than solution polymerization (e.g., emulsion polymerization, photopolymerization, or bulk polymerization) and dissolving the polymer in an organic solvent.

When the acrylic polymer in the techniques disclosed herein has too low a weight-average molecular weight (Mw), there can be cases where the pressure-sensitive adhesive is prone to have insufficient cohesive force to cause adhesive transfer to adherend surfaces or is prone to have reduced adhesiveness to curved surfaces. Meanwhile, when the Mw thereof is too high, there can be cases where the pressure-sensitive adhesive is prone to have reduced pressure-sensitive adhesive force in application to adherends. From the standpoint of balancing pressure-sensitive adhesive performance with re-releasability on a high level, an acrylic polymer having an Mw in the range of 10×10⁴ to 500×10⁴ is preferred. An acrylic polymer having an Mw of 20×10⁴ to 100×10⁴ (e.g., 30×10⁴ to 70×10⁴) can bring about better results. In this specification, the values of Mw are ones obtained through GPC (gel permeation chromatography) and calculated for standard polystyrene.

The pressure-sensitive adhesive compositions in the techniques disclosed herein can be compositions which contain a tackifier resin. The tackifier resin is not particularly limited, and use can be made of various tackifier resins including, for example, rosin-based resins, terpene-based resins, hydrocarbon-based resins, epoxy resins, polyamide-based resins, elastomer-based resins, phenolic resins, and ketone-based resins. One of such tackifier resins can be used alone, or two or more thereof can be used in combination.

Examples of the rosin-based tackifier resins include: unmodified rosins (crude rosins) such as gum rosin, wood rosin, and tall oil rosin; modified rosins (hydrogenated rosins, disproportionated rosins, polymerized rosins, and other chemically modified rosins) obtained by modifying those unmodified rosins by hydrogenation, disproportionation, polymerization, etc.; and other rosin derivatives. Examples of the rosin derivatives include: rosin esters such as ones (esterified rosins) obtained by esterifying unmodified rosins with an alcohol and ones (esterified modified rosins) obtained by esterifying modified rosins (hydrogenated rosins, disproportionated rosins, polymerized rosins, etc.) with an alcohol; unsaturated-fatty-acid-modified rosins obtained by modifying unmodified rosins or modified rosins (hydrogenated rosins, disproportionated rosins, polymerized rosins, etc.) with an unsaturated fatty acid; unsaturated-fatty-acid-modified rosin esters obtained by modifying rosin esters with an unsaturated fatty acid; rosin alcohols obtained by reducing at least some of the carboxyl groups of unmodified rosins, modified rosins (hydrogenated rosins, disproportionated rosins, polymerized rosins, etc.), unsaturated-fatty-acid-modified rosins, or unsaturated-fatty-acid-modified rosin esters; metal salts of rosins such as unmodified rosins, modified rosins, and various rosin derivatives (in particular, rosin esters); and rosin-phenol resins obtained by causing phenol to add to rosins (unmodified rosins, modified rosins, various rosin derivatives, etc.) with the aid of an acid catalyst and thermally polymerizing the addition products.

Examples of the terpene-based tackifier resins include: terpene-based resins such as α-pinene polymers, β-pinene polymers, and dipentene polymers; and modified terpene-based resins obtained by modifying these terpene-based resins (by modification with phenol, modification with an aromatic, modification by hydrogenation, modification with a hydrocarbon, etc.). Examples of the modified terpene resins include terpene-phenol resins, styrene-modified terpene-based resins, aromatic-modified terpene-based resins, and hydrogenated terpene-based resins.

Examples of the hydrocarbon-based tackifier resins include various hydrocarbon-based resins such as aliphatic-hydrocarbon resins, aromatic-hydrocarbon resins, alicyclic-hydrocarbon resins, aliphatic/aromatic petroleum resins (e.g., styrene/olefin copolymers), aliphatic/alicyclic petroleum resins, hydrogenated hydrocarbon resins, coumarone-based resins, and coumarone-indene resins. Examples of the aliphatic-hydrocarbon resins include polymers of one or more aliphatic hydrocarbons selected from among olefins and dienes which have about 4 or 5 carbon atoms. Examples of the olefins include 1-butene, isobutylene, and 1-pentene. Examples of the dienes include butadiene, 1,3-pentadiene, and isoprene. Examples of the aromatic-hydrocarbon resins include polymers of vinyl-group-containing aromatic hydrocarbons having about 8-10 carbon atoms (e.g., styrene, vinyltoluene, α-methylstyrene, indene, and methylindene). Examples of the alicyclic-hydrocarbon resins include: alicyclic-hydrocarbon-based resins obtained by subjecting a so-called “C4 petroleum fraction” or “C5 petroleum fraction” to cyclizing dimerization and then polymerizing the dimerization product; polymers of cyclodiene compounds (e.g., cyclopentadiene, dicyclopentadiene, ethylidenenorbornene, and dipentene) or products of hydrogenation of these polymers; and alicyclic-hydrocarbon-based resins obtained by hydrogenating the aromatic rings of either aromatic-hydrocarbon resins or aliphatic/aromatic petroleum resins.

In the techniques disclosed herein, a tackifier resin having a softening point (softening temperature) of about 80° C. or higher (preferably about 100° C. or higher) can be preferably used. With this tackifier resin, an adhesive sheet having higher performance (e.g., high adhesiveness) can be rendered possible. There is no particular upper limit on the softening point of the tackifier resin, and the softening point thereof can be about 200° C. or lower (typically about 180° C. or lower). The term “softening point of a tackifier resin” used herein is defined as a value measured through the softening point measuring method (ring-and-ball method) as defined in JIS K5902:1969 or JIS K2207:1996.

The amount of the tackifier resin to be used is not particularly limited, and can be suitably set in accordance with desired pressure-sensitive adhesive performance (adhesive strength, etc.). For example, it is preferred to use the tackifier resin in an amount of about 10-100 parts by mass (more preferably 15-80 parts by mass, even more preferably 20-60 parts by mass) on a solid basis per 100 parts by mass of the acrylic polymer.

A crosslinking agent may be used in the pressure-sensitive adhesive compositions according to need. The kind of the crosslinking agent is not particularly limited, and use can be made of a crosslinking agent suitably selected from among known or common crosslinking agents (e.g., isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal-alkoxide-based crosslinking agents, metal-chelate-based crosslinking agents, metal-salt-based crosslinking agents, carbodiimide-based crosslinking agents, and amine-based crosslinking agents). One crosslinking agent can be used alone, or two or more crosslinking agents can be used in combination. The amount of the crosslinking agent to be used is not particularly limited, and the amount thereof can be selected, for example, from the range of up to about 10 parts by mass (for example, about 0.005-10 parts by mass, preferably about 0.01-5 parts by mass) per 100 parts by mass of the acrylic polymer.

The pressure-sensitive adhesive compositions can be ones which, according to need, contain various additives that are common in the field of pressure-sensitive adhesive compositions, such as leveling agents, crosslinking aids, plasticizers, softeners, fillers, colorants (pigments, dyes, etc.), antistatic agents, antioxidants, ultraviolet absorbers, oxidation inhibitors, and light stabilizers. With respect to such various additives, conventionally known ones can be used in ordinary ways. Since such additives do not especially characterize the present invention, detailed explanations thereon are omitted here.

In the first embodiment, the adhesive layer 3 which is disposed on one surface of the substrate 2 is configured so as to include: regions 35 constituted of an adhesive having a high adhesive force to the release liner 4; and regions 36 constituted of an adhesive having a low adhesive force to the release liner 4. However, the adhesive sheet 1 is not limited to ones having such a configuration. For example, an adhesive layer 3 may be formed by disposing adhesives differing in plasticity in regions 35 and regions 36, respectively. Specifically, an adhesive layer 3 may be formed from selected adhesives which are: an adhesive that has high plasticity and is to be disposed in the regions 35 corresponding to the second areas 3b (small domains 31); and an adhesive that has lower plasticity than the adhesive to be disposed in the second areas 3b and that is to be disposed in the regions 36 corresponding to the first areas 3a. In the case of employing such a configuration, the predetermined portions of the adhesive layer 3, which have high plasticity, follow up the release liner 4 being peeled off and deform so as to protrude upward as shown in FIG. 3B. It is hence possible to effectively form surface irregularities on the application surface of the adhesive layer 3 by peeling off the release liner 4, and the effect described above, i.e., the function of sufficiently expelling air bubbles, can be exhibited.

Next, the second embodiment according to the present invention is explained. An adhesive sheet according to the second embodiment includes a substrate 2, a release liner 4, and an adhesive layer 3. The adhesive layer 3 is interposed between the substrate 2 and the release liner 4. The adhesive sheet according to the second embodiment is characterized by the structure of the adhesive layer 3. As the substrate 2, use can be made of one which is generally used as the substrates 2 of adhesive sheets, as stated above. With respect to the release liner 4 also, the configuration including a liner base and a release layer (releasing coating film) can be employed, as stated above.

The adhesive layer 3 in the second embodiment is configured so that, as shown in the plan view of FIG. 4, regions corresponding to the second areas 3b (small domains 31) have slits 38 formed by incising the adhesive layer 3 in the thickness direction thereof. In FIG. 4, a spiral slit 38 is formed in each small domain 31. Each slit 38 may be configured of perforations. Each slit 38 may be in the so-called half-cut state, or may pierce the whole thickness of the adhesive layer 3.

In the case where slits 38 formed by incising the adhesive layer 3 in the thickness direction thereof are provided to those regions in the adhesive layer 3 which correspond to the small domains 31, the predetermined portions (corresponding to the small domains 31 in the second areas 3b) of the adhesive layer 3 which have the slits 38 formed therein are more apt to follow up the release liner 4 when the release liner 4 is peeled from the adhesive layer 3. It is hence possible to make the predetermined portions protrude upward from the other portions (corresponding to the first areas 3a) of the adhesive layer 3 to thereby form surface irregularities on the application surface of the adhesive layer 3, and the effect described above, i.e., the function of sufficiently expelling air bubbles, can be exhibited.

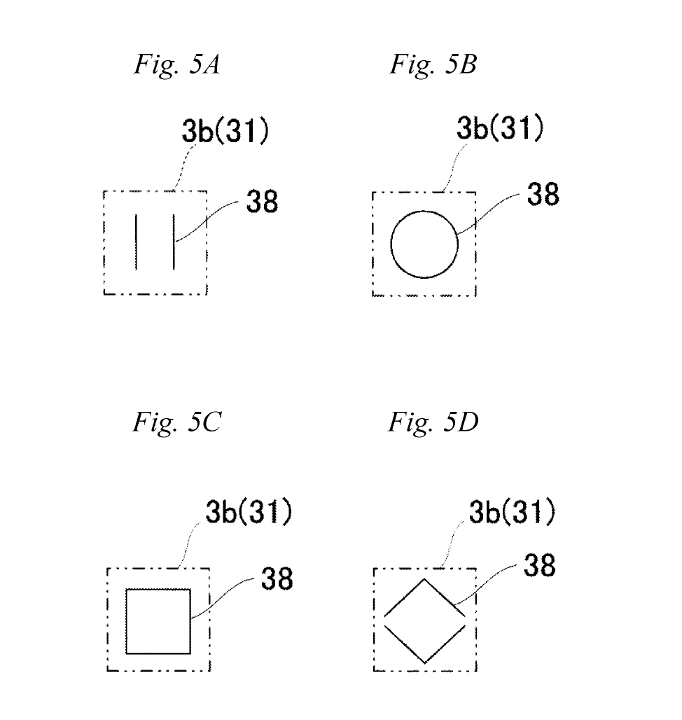

In the second embodiment, the adhesive layer 3 is configured so that spiral slits 38 are formed in the small domains 31, as shown in FIG. 4. However, the configuration of the slits 38 is not particularly limited so long as portions (corresponding to the second areas 3b (small domains 31)) of the adhesive layer 3 can follow up the release liner 4 being peeled off and can thus deform so as to protrude upward. For example, slits 38 can be formed in various arrangements as shown in FIGS. 5A to 5D. FIG. 5A shows a small domain 31 in which two linear parallel slits 38 are formed. FIG. 5B shows a small domain in which a circular slit 38 is formed. FIG. 5C shows a small domain 31 in which a rectangular slit 38 is formed. FIG. 5D shows a small domain 31 in which two V-shaped slits 38 are disposed so that the open ends thereof face each other.

Next, the third embodiment according to the present invention is explained. An adhesive sheet according to the third embodiment includes a substrate 2, a release liner 4, and an adhesive layer 3. The adhesive layer 3 is interposed between the substrate 2 and the release liner 4. The adhesive sheet according to the third embodiment is characterized by the structure of the release liner 4. As the substrate 2, use can be made of one which is generally used as the substrates 2 of adhesive sheets, as stated above. With respect to the adhesive layer 3 also, any of the various adhesives described above can be used to form the adhesive layer 3.

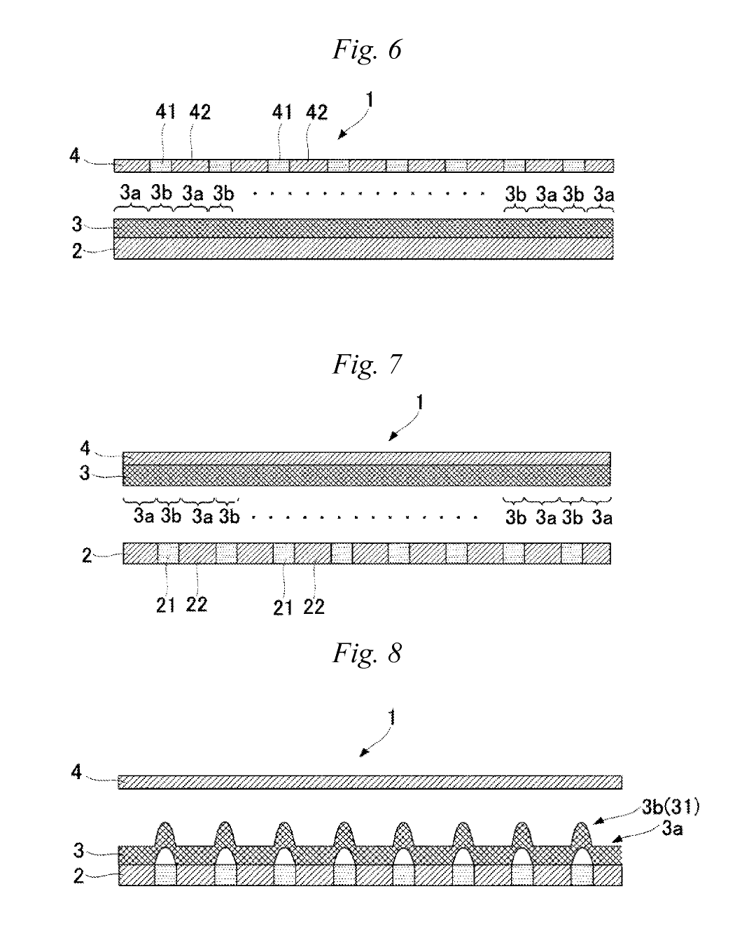

The adhesive sheet according to the third embodiment is characterized in that the release liner 4 is configured so that the surface (surface facing the adhesive layer 3) of regions 41 in the release liner 4 which correspond to the second areas 3b (small domains 31) has lower releasability from the adhesive layer 3 than the surface (surface facing the adhesive layer 3) of regions 42 in the release liner 4 which correspond to the first areas 3a, as shown in, for example, the cross-sectional view of FIG. 6. For convenience of illustration, FIG. 6 shows an adhesive sheet in the state where the release liner 4 has not been disposed on the surface of the adhesive layer 3.

A more specific explanation is given below. The release liner 4, which is a member having a configuration including a liner base and a release layer (releasing coating film) as stated above, is configured so that the regions 41 in the release layer which correspond to the second areas 3b (small domains 31) have lower releasability from the adhesive layer 3 than the regions 42 in the release layer which correspond to the first areas 3a. For example, in the case where the adhesive layer 3 is formed from a silicone-based adhesive, the release-layer regions corresponding to the second areas 3b (small domains 31) are formed from a silicone-based release agent and the release-layer regions corresponding to the first areas 3a are formed from a fluorine-based release agent. Thus, with respect to the releasability of the release liner 4 from the adhesive layer 3, the regions corresponding to the first areas 3a can be rendered unequal to the regions corresponding to the second areas 3b.

The release-layer regions (regions corresponding to the first areas 3a) formed from a fluorine-based release agent show high releasability from the adhesive layer 3 constituted of a silicone-based adhesive. Consequently, when peeling the release liner 4 from the adhesive layer 3, the release-layer regions are smoothly separated from the adhesive layer 3, and the adhesive layer 3 is less apt to show a deformation which protrudes upward. Meanwhile, the release-layer regions (regions corresponding to the second areas 3b) formed from a silicone-based release agent show poor releasability from the adhesive layer 3 constituted of a silicone-based adhesive and, hence, the adhesive layer 3 adheres to those regions in the release liner 4 which is being peeled from the adhesive layer 3. As a result, those regions in the adhesive layer 3 which correspond to the second areas 3b follow up the release liner 4 with the peeling of the release liner 4 and deform so as to protrude upward as shown in FIG. 2B.

In this adhesive sheet according the third embodiment, in which the release liner 4 is configured so that the surface of the regions 41 corresponding to the second areas 3b (small domains 31) has lower releasability from the adhesive layer 3 than the surface of the regions 42 corresponding to the first areas 3a, it is possible to effectively form surface irregularities on the application surface of the adhesive layer 3 by peeling off the release liner 4, and the effect described above, i.e., the function of sufficiently expelling air bubbles, can be exhibited.

It is preferable that the ratio of the peel force, regarding peeling from the adhesive layer 3, of the surface of the regions 42 corresponding to the first areas 3a to the peel force, regarding peeling from the adhesive layer 3, of the surface of the regions 41 corresponding to the second areas 3b (small domains 31) is set so as to be in the range of from 1:5 to 1:200. The ratio between the peel forces can be determined by measuring the peel forces in the following manner. First, the adhesive sheet 1 is cut into a size having a width of 50 mm and a length of 150 mm to produce a sample for evaluation. Subsequently, the surface on the substrate 2 side is adhered to a coated plate with a double-faced tape, and the release liner 4 is then peeled off to measure the force required for peeling off the regions 42 corresponding to the first areas 3a and the force required for peeling off the regions 41 corresponding to the second areas 3b (small domains 31). With respect to the measurement conditions, universal tensile tester “TCM-1kNB”, manufactured by Minebea Co., Ltd., is used to conduct 180-degree peeling at a pulling speed of 300 mm/min in an atmosphere of 23° C. and 50% RH.

In the third embodiment, there are no particular limitations on the adhesive for forming the adhesive layer 3 and the materials for forming the release layer of the release liner 4 and any materials may be used, so long as the release liner 4 can be made to have a difference in releasability from the adhesive layer 3 so that by the operation of peeling off the release liner 4, portions (corresponding to the second areas 3b) of the adhesive layer 3 can be caused to follow up the release liner 4 and deform so as to protrude upward.

In the third embodiment, the release-layer regions corresponding to the second areas 3b (small domains 31) are formed from a silicone-based release agent and the release-layer regions corresponding to the first areas 3a are formed from a fluorine-based release agent, thereby attaining a configuration in which the releasability of the regions corresponding to the second areas 3b is lower than the releasability of the regions corresponding to the first areas 3a. However, the adhesive sheet 1 is not limited to ones having such a configuration. For example, the release liner 4 can be configured so that the surface roughness of the release-layer regions corresponding to the second areas 3b (small domains 31) is higher than the surface roughness of the release-layer regions corresponding to the first areas 3a. With this configuration also, the surface of the regions 41 in the release liner 4 which correspond to the second areas 3b (small domains 31) can be made to have lower releasability from the adhesive layer 3 than the surface of the regions 42 in the release liner 4 which correspond to the first areas 3a. Consequently, when peeling off the release liner 4, the predetermined portions (portions corresponding to the second areas 3b) which are the release-layer regions having high surface roughness pull and lift up the corresponding portions of the adhesive layer 3. As a result, the adhesive layer 3 follows up the release liner 4 being peeled off and deforms so as to protrude upward as shown in FIG. 2B. It is hence possible to effectively form surface irregularities on the application surface of the adhesive layer 3 by peeling off the release liner 4, and the effect described above, i.e., the function of sufficiently expelling air bubbles, can be exhibited.

Next, the fourth embodiment according to the present invention is explained. An adhesive sheet 1 according to the fourth embodiment includes a substrate 2, a release liner 4, and an adhesive layer 3. The adhesive layer 3 is interposed between the substrate 2 and the release liner 4. The adhesive sheet according to the fourth embodiment is characterized by the structure of the substrate 2, and the adhesive layer 3 can be formed using any of the various adhesives described above. With respect to the release liner 4 also, the configuration including a liner base and a release layer (releasing coating film) can be employed as described above.

The adhesive sheet according to the fourth embodiment is characterized in that the substrate 2 is configured so that the surface (surface facing the adhesive layer 3) of regions 21 in the substrate 2 which correspond to the second areas 3b (small domains 31) has higher releasability from the adhesive layer 3 than the surface (surface facing the adhesive layer 3) of regions 22 in the substrate 2 which correspond to the first areas 3a, as shown in, for example, the cross-sectional view of FIG. 7. For convenience of illustration, FIG. 7 shows an adhesive sheet in a state where the substrate 2 is separated from the adhesive layer.

A more specific explanation is given below. In one surface of the substrate 2, two kinds of regions which differ in releasability are formed, for example, by applying a fluororesin coating layer on the surface of regions 21 in the substrate 2 which correspond to the second areas 3b (small domains 31) and applying a silicone-resin coating layer on the surface of regions 22 corresponding to the first areas 3a. In cases when a substrate 2 having such a configuration is employed, the following effect is brought about. For example, in the case where the adhesive layer 3 is formed from a silicone-based adhesive, the predetermined regions (regions corresponding to the first areas 3a) in the surface of the substrate 2 that have the silicone-resin coating layer show low releasability from the adhesive layer 3 constituted of a silicone-based adhesive. Consequently, when peeling the release liner 4 from the adhesive layer 3, portions of the adhesive layer 3 which correspond to the low-releasability regions in the substrate 2 remain on the substrate 2 without being separated from the substrate 2. Meanwhile, the surface of the substrate 2 (regions corresponding to the second areas 3b) where a fluororesin coating layer is formed shows high releasability from the adhesive layer 3 constituted of a silicone-based adhesive. Consequently, portions of the adhesive layer 3 formed on such a surface of the substrate 2 are lifted up therefrom with the movement of the release liner 4 being peeled from the adhesive layer 3, and thus follow up the release liner 4 and deform so as to protrude upward as shown in the cross-sectional view of FIG. 8.

In the adhesive sheet according to the fourth embodiment, in which the substrate 2 is configured so that the surface of the regions 21 corresponding to the second areas 3b (small domains 31) has higher releasability from the adhesive layer 3 than the surface of the regions 22 corresponding to the first areas 3a, it is possible to effectively form surface irregularities on the application surface of the adhesive layer 3 by peeling off the release liner 4, and the effect described above, i.e., the function of sufficiently expelling air bubbles, can be exhibited.

It is preferable that the ratio of the peel force, regarding peeling from the adhesive layer 3, of the surface of the regions 22 corresponding to the first areas 3a to the peel force, regarding peeling from the adhesive layer 3, of the surface of the regions 21 corresponding to the second areas 3b (small domains 31) is set so as to be in the range of from 1:5 to 1:200. The ratio between the peel forces can be determined by measuring the peel forces in the following manner. First, the adhesive sheet 1 is cut into a size having a width of 50 mm and a length of 150 mm to produce a sample for evaluation. Subsequently, the surface on the substrate 2 side is adhered to a coated plate with a double-faced tape, and the release liner 4 is then peeled off to measure the force required for peeling off the regions 22 corresponding to the first areas 3a and the force required for peeling off the regions 21 corresponding to the second areas 3b (small domains 31). With respect to the measurement conditions, universal tensile tester “TCM-1kNB”, manufactured by Minebea Co., Ltd., is used to conduct 180-degree peeling at a pulling speed of 300 mm/min in an atmosphere of 23° C. and 50% RH.

In the fourth embodiment, there are no particular limitations on the adhesive for forming the adhesive layer 3 and the materials for forming the coating layers on one surface of the substrate 2 and any materials may be used, so long as the substrate 2 can be made to have a difference in releasability from the adhesive layer 3 so that by the operation of peeling off the release liner 4, portions (corresponding to the second areas 3b) of the adhesive layer 3 can be caused to follow up the release liner 4 and deform so as to protrude upward.

In the fourth embodiment, a fluororesin coating layer is formed in one-surface regions in the substrate 2 which correspond to the second areas 3b (small domains 31), and a silicone-resin coating is formed in one-surface regions in the substrate 2 which correspond to the first areas 3a. The substrate 2 is thus configured so that the one surface of the substrate 2 has two kinds of regions which differ in releasability. However, the adhesive sheet 1 is not limited to ones having such a configuration. For example, the substrate 2 can be configured so that the surface roughness of the regions 21 in the substrate 2 which correspond to the second areas 3b (small domains 31) is lower than the surface roughness of the regions 22 in the substrate 2 which correspond to the first areas 3a. With this configuration also, the surface of the regions 21 in the substrate 2 which correspond to the second areas 3b (small domains 31) can be made to have higher releasability from the adhesive layer 3 than the surface of the regions 22 in the substrate 2 which correspond to the first areas 3a. Consequently, when peeling off the release liner 4, the portions (corresponding to the second areas 3b) of the adhesive layer formed on portions of the surface of the substrate 2 that have low surface roughness are lifted up with the movement of the release liner 4, and thus follow up the release liner 4 and deform so as to protrude upward as shown in FIG. 8. It is hence possible to effectively form surface irregularities on the application surface of the adhesive layer 3 by peeling off the release liner 4, and the function of sufficiently expelling air bubbles can be exhibited.

Although adhesive sheets according to the first to fourth embodiments of the present invention have been explained above, it is a matter of course that the characterizing portions of the embodiments may be combined to configure an adhesive sheet 1 according to the present invention. For example, the slits 38 explained with regard to the second embodiment may be formed in the adhesive layer 3 of the adhesive sheet 1 according to the first embodiment, thereby configuring an adhesive sheet 1. Alternatively, the structure of release liner 4 explained with regard to the third embodiment may be applied to the release liner 4 of the adhesive sheet 1 according to the second embodiment, thereby configuring an adhesive sheet 1. Moreover, an adhesive sheet 1 may be configured so as to include all the structural features of the first to the fourth embodiments.

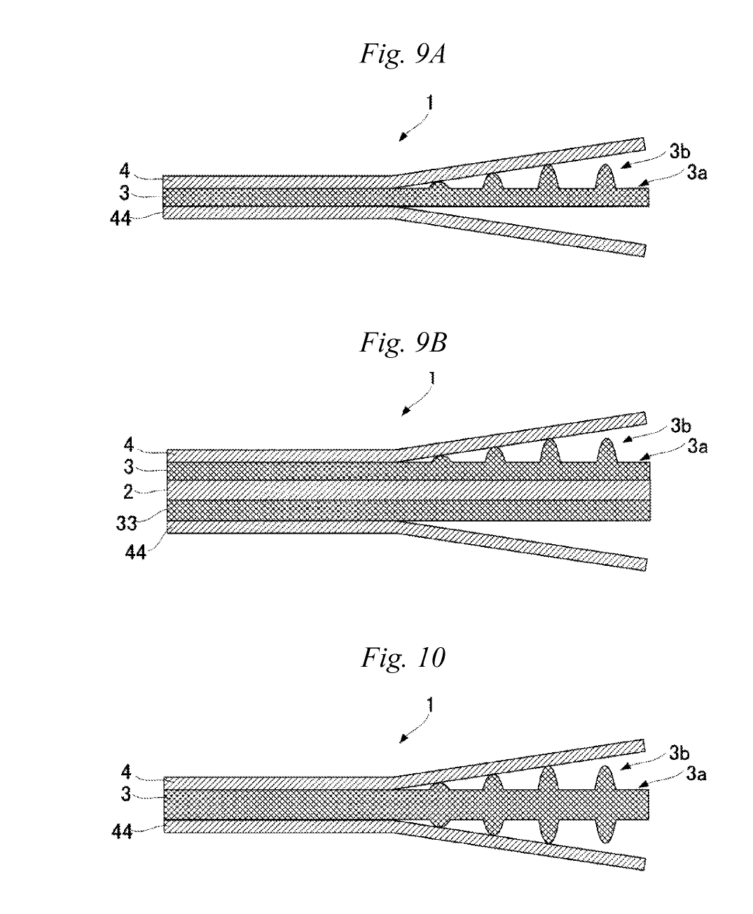

Furthermore, the adhesive sheets 1 according to the first to the fourth embodiments each are configured as an adhesive sheet of the one-side adhesion type which includes an adhesive layer 3 formed on one surface of the substrate 2 and in which an adherend Z is adhered to one-side surface of the adhesive sheet 1, as shown in, for example, FIG. 2. However, the substrate 2 in the adhesive sheet 1 is not an essential constituent element of the present invention, and the adhesive sheet 1 may be configured so as to include no substrate 2. Namely, the adhesive sheet 1 may be configured as the both-side adhesion type in which adherends are adhered respectively to both surfaces of the adhesive layer 3 so that the adhesive layer 3 is interposed therebetween. In the case of forming the adhesive sheet 1 as an adhesive sheet of such both-side adhesion type, this adhesive sheet is configured, for example, so that a release liner 4 is disposed on one surface of an adhesive layer 3 and a second release liner 44 is disposed on the other surface thereof as shown in FIG. 9A. Specific structures in the case of configuring the adhesive sheet 1 as an adhesive sheet of the both-side adhesion type are not particularly limited to the substrate-less type described above. For example, an adhesive sheet may be configured by forming an adhesive layer 3 on one surface of a substrate 2, forming a second adhesive layer 33 on the other surface thereof, and superposing release liners 4 and 44 on the exposed surfaces of the adhesive layers 3 and 33, as shown in FIG. 9B. FIGS. 9A and 9B each show an adhesive sheet 1 in a state in which the release liners 4 and 44 are partly peeled off.

Although the embodiments described above have a structure in which surface irregularities capable of forming channels for expelling air bubbles are formed on one surface of an adhesive layer 3, the adhesive sheet of the present invention is not limited to ones having such a structure. For example, the adhesive sheet 1 can be configured as an adhesive sheet of the both-side adhesion type in which surface irregularities capable of forming channels for expelling air bubbles are formed on each of both surfaces of an adhesive layer 3, as shown in FIG. 10. FIG. 10 shows an adhesive sheet 1 in which the release liners 4 and 44 are partly peeled off.

The present application is based on Japanese Patent Application No. 2015-186182 filed on Sep. 23, 2015, the contents of which are incorporated herein by reference.

### DESCRIPTION OF REFERENCE NUMERALS AND SIGNS

1 Adhesive sheet
2 Substrate
3 Adhesive layer
4 Release liner
5 Channel area (gap)
Z Adherend

What is claimed is:

1. An adhesive sheet comprising an adhesive layer and a release liner disposed on one surface of the adhesive layer,
wherein the adhesive layer is configured so as to show follow-up deformations in response to peeling of the release liner from the adhesive layer and have first areas having a first follow-up deformation height and second areas having a second follow-up deformation height, in which the first follow-up deformation height is a height dimension of the follow-up deformation in the first areas, the second follow-up deformation height is a height dimension of the follow-up deformation in the second areas, and the second follow-up deformation height is larger than the first follow-up deformation height.

2. The adhesive sheet according to claim 1, wherein a difference between the second follow-up deformation height and the first follow-up deformation height is 0.5 μm to 500 μm.

3. The adhesive sheet according to claim 1, wherein the second areas comprise a plurality of small domains dispersedly formed in the adhesive layer, and the first areas are disposed so as to surround each small domain.

4. The adhesive sheet according to claim 3, wherein an adhesive disposed in regions in the adhesive layer which correspond to the small domains has a higher adhesive force or higher plasticity than an adhesive disposed in regions in the adhesive layer which correspond to the first areas.

5. The adhesive sheet according to claim 3, wherein the regions in the adhesive layer which correspond to the small domains have slits formed by incising the adhesive layer in a thickness direction thereof.

6. The adhesive sheet according to claim 3, wherein a surface of regions in the release liner which correspond to the small domains has lower releasability from the adhesive layer than a surface of regions in the release liner which correspond to the first areas.

7. The adhesive sheet according to claim 3, wherein the adhesive sheet further comprises a substrate on which the adhesive layer is disposed, and a surface of regions in the substrate which correspond to the small domains has higher releasability from the adhesive layer than a surface of regions in the substrate which correspond to the first areas.

8. An adhesive-sheet application method for applying to an adherend an adhesive sheet comprising an adhesive layer and a release liner disposed on one surface of the adhesive layer, the method comprising: a step in which the release liner is peeled from the adhesive layer, whereby portions of the adhesive layer is caused to follow up the release liner to form surface irregularities on the adhesive layer.
